(19) United States
(12) Patent Application Publication
(10) Pub. No.: US 2021/0039032 A1
(43) Pub. Date: Feb. 11, 2021

(54) ATMOSPHERE PURIFICATION APPARATUS USING FLYING OBJECT, AND ATMOSPHERE PURIFICATION AND TREATMENT METHOD

(71) Applicants: Hyeokjun KWEON, Goyang-si (KR); Jinwoo OH, Seoul (KR); Dongok KIM, Goyang-si (KR); Jeonghyun PARK, Seoul (KR)

(72) Inventors: Hyeokjun KWEON, Goyang-si (KR); Jinwoo OH, Seoul (KR); Dongok KIM, Goyang-si (KR); Jeonghyun PARK, Seoul (KR)

(21) Appl. No.: 17/041,494

(22) PCT Filed: Mar. 28, 2019
(86) PCT No.: PCT/KR2019/003634

§ 371 Date: Sep. 25, 2020

(30) Foreign Application Priority Data
Mar. 29, 2018 (KR) 10-2018-0036836

(51) Int. Cl. B01D 46/44; B64C 39/02

(52) U.S. Cl. CPC B01D 46/442; B64C 39/024; B64B 1/30; B64C 2201/12; B01D 2279/40

(57) ABSTRACT

The present invention relates generally to an atmosphere purification apparatus using a flying object and an atmosphere purification and treatment method, and more particularly to an atmosphere purification apparatus using a flying object and an atmosphere purification and treatment method that are configured to specify a contaminated location and region in the atmosphere and remove contaminants scattered in the atmosphere by using a flying object that stays within a predetermined region or circulates while adjusting an altitude. For this purpose, the atmosphere purification apparatus includes a flying object filled with a gas having a lower specific gravity than that of air therein and an air purification unit provided on one side of the flying object, and configured to remove contaminants introduced thereinto, and removes contaminants in the atmosphere within a region having a height from the ground.

### TECHNICAL FIELD

The present invention relates generally to an atmosphere purification apparatus using a flying object and an atmosphere purification and treatment method, and more particularly to an atmosphere purification apparatus using a flying object and an atmosphere purification and treatment method that are configured to specify a contaminated location and region in the atmosphere and remove contaminants scattered in the atmosphere by using a flying object that stays within a predetermined region or circulates while adjusting an altitude.

### BACKGROUND ART

In general, society today is in a situation in which there is increasing atmospheric contamination attributable to increases in the exhaust gas (emissions) caused by rapid industrialization and vehicles, smog, dust, pollen, yellow dust, fine dust, etc.

Atmospheric contamination refers to environmental contamination in the atmosphere, and means the state in which contaminants beyond the self-cleaning capacity of the atmosphere have been released into the atmosphere.

Fine dust is only one type of substance of the substances that cause atmospheric contamination, contaminants include not only fine dust but also carbon dioxide, yellow dust, ozone, radon, toxic gases, etc., and there are numerous causes of atmospheric contamination.

Therefore, as a countermeasure against atmospheric contamination, individual generation facilities are regulated by designating fixed contaminant sources such as factories by law, setting contaminant emission standards, regulating the quality of fuel used, shortening operations in urgent cases, etc.

Furthermore, when it is difficult to achieve environmental standards only by regulating individual generation facilities, there is employed a method of designating a specific area and then regulating the total amount of emissions from factories in the area.

However, most of the countermeasures are taken in the form of regulations on the emission of harmful substances. The reason for this is that it is significantly difficult to reduce or remove atmospheric contaminants once they are released into the atmosphere.

Therefore, in connection with countermeasures against atmosphere contamination, continuous regulation and prevention are most important.

Meanwhile, conventionally, atmosphere purification apparatuses are installed in indoor areas and purify only indoor air, and there are no special purification facilities for purifying outdoor air. Accordingly, in order to purify air within specific spaces, atmosphere purification apparatuses are installed mainly in closed buildings and purify the air.

However, the conventional technology purifies air only at predetermined points, and has a problem in that atmosphere purification is not performed in an atmospheric space in an area where there are only buildings in which atmosphere purification apparatuses are not installed or there are no buildings in which atmosphere purification apparatuses can be installed.

Furthermore, currently, there is a phenomenon in which fine dust or the like is severe only in a partial area in the atmosphere. There is a demand for an apparatus capable of easily removing contaminants such as fine dust in the atmosphere.

(Patent document 1) Korean Patent No. 10-0764014 (registered on Sep. 28, 2007)

### DISCLOSURE

### Technical Problem

The present invention has been conceived to overcome the above-described problems of the prior art, and an object of the present invention is to provide an atmosphere purification apparatus using a flying object and an atmosphere purification and treatment method that are configured to remove contaminants scattered in the atmosphere within a specific contaminated region by using a flying object that can stay within a predetermined region or circulate while adjusting an altitude.

### Technical Solution

In order to accomplish the above object, an atmosphere purification apparatus using a flying object according to the present invention includes: a flying object filled with a gas having a lower specific gravity than that of air therein; and an air purification unit provided on one side of the flying object, and configured to remove contaminants introduced thereinto.

According to the above configuration, the atmosphere purification apparatus guides contaminants in the atmosphere within a region having a height from the ground into the air purification unit and removes the contaminants.

In this case, the flying object is preferably any one of an airship, a hot-air balloon, and a gas balloon.

Furthermore, the flying object further includes an advertisement unit configured to display an advertising phrase on one side thereof, and a wind direction sensor configured to measure a direction of the wind.

In addition, the air purification unit is provided below the flying object; and includes a case provided with mesh nets on front and rear sides thereof, a filter provided inside the case, and fans disposed in front of and behind the filter and configured to guide external air toward the filter or provide propulsion force to move the flying object.

In addition, the atmosphere purification apparatus using a flying object according to the present invention further includes a support cable configured such that one end thereof is connected and fastened to one side of the flying object or air purification unit and the other end thereof is installed and fastened at a set point in the ground by a fastening member.

Furthermore, the flying object or air purification unit further includes fan propellers configured to obtain propulsion force on one side thereof, as needed.

Additionally, the flying object or air purification unit further includes, on one side thereof, a contamination level sensor configured to measure a contamination level including fine dust at a located point.

Moreover, an atmosphere purification and treatment method using an atmosphere purification apparatus using a flying object in order to remove contaminants scattered in an atmosphere within a specific contaminated region includes: a contaminated region search and measurement step including the process of primarily moving the atmosphere purification apparatus using a flying object, equipped with a contamination level sensor, the process of measuring a contamination level for each location and altitude, and the process of transmitting measured contamination levels and locations to a control tower on a ground; a contaminated region specifying step of specifying the location and altitude of a contaminated region based on the measured contamination levels; and a specified contaminated region reaching and purification step (S3) including the process of secondarily moving the atmosphere purification apparatus using a flying object, equipped with the contamination level sensor and an air purification unit, to the specified contaminated region, and the process of performing atmosphere purification and treatment using the air purification unit.

### Advantageous Effects

As described above, the atmosphere purification apparatus using a flying object and the atmosphere purification and treatment method according to the present invention remove contaminants scattered in the atmosphere by using the atmospheric purification apparatus while staying within a predetermined region or circulating by adjusting an altitude using the flying object in an area where a purification apparatus cannot be installed because there is no building having a height, thereby achieving the effect of increasing atmosphere contamination removal efficiency.

Furthermore, the present invention has the effect of searching for and moving to a contaminated space in the atmosphere according to the measured values of the wind direction sensor and the contamination level sensor and intensively purifying the contaminated space in the atmosphere, thereby maximizing treatment efficiency.

### DESCRIPTION OF DRAWINGS

FIGS. 1 and 2 are diagrams showing an atmosphere purification apparatus using a flying object according to an embodiment of the present invention;

FIG. 3 is a diagram showing a state in which the atmosphere purification apparatus using a flying object according to the embodiment of the present invention is used;

FIGS. 4 and 5 are diagrams showing an atmosphere purification apparatus using a flying object according to another embodiment of the present invention;

FIG. 6 is a diagram showing a state in which the atmosphere purification apparatus using a flying object according to the other embodiment of the present invention is used; and

FIG. 7 is a schematic flowchart showing atmosphere purification and treatment method using an atmosphere purification apparatus using a flying object according to the present invention.

### BEST MODE

Preferred embodiments of an atmosphere purification apparatus using a flying object and an atmosphere purification and treatment method according to the present invention will be described in detail below with reference to the accompanying drawings.

Furthermore, in the description of the present invention, the upper portion or upward direction refers to a portion having a height from a bottom surface or the direction of the portion, and the lower portion or downward direction refers to the portion opposite to the upper portion or the direction opposite to the direction of the upper portion.

Moreover, the forward direction refers to the direction in which a flying object moves forward or a portion located in this direction, and the rearward direction refers to the direction opposite to the forward direction or a portion located in this direction.

In addition, in the description of the present invention, detailed descriptions of related known functions or configurations will be omitted in order to prevent the gist of the present invention from being obscured.

As shown in the drawings, an atmosphere purification apparatus 1 using a flying object according to the present invention is formed by integrating an air purification unit 120 with a flying object 110 that can float in the atmosphere, and is configured to guide contaminants in the atmosphere within a region having a height from the ground F to the air purification unit 120 and easily purify them.

Furthermore, it may be possible to search for and move to a contaminated space while easily adjusting an altitude by using the flying object 110, thereby increasing purification efficiency.

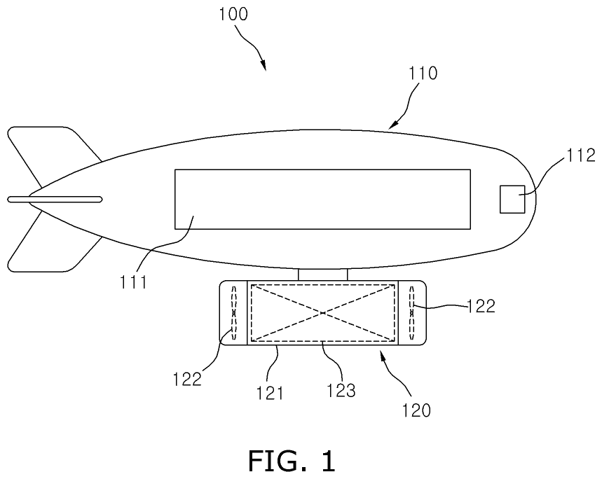

As an embodiment for this, the atmosphere purification apparatus 100 using a flying object according to the present invention will be described with reference to FIGS. 1 to 3, as follows.

As shown in the drawings, the atmosphere purification apparatus 100 using a flying object according to the present invention is configured to include the flying object 110 filled with a gas having a lower specific gravity than that of air therein and the air purification unit 120 provided on one side of the flying object 110 and configured to remove contaminants introduced thereinto.

In this case, the flying object 110 is filled with a gas having a specific gravity lower than that of air, as described above, and the flying object 110 is shown in the form of an airship in the illustration of one embodiment.

Meanwhile, any type of device may be applicable as the flying object 110 as long as the device can move the air purification unit 120, provided in an integrated manner, to a position requiring air purification in the atmosphere and also maintain the position even under the influence of convection by a powered or non-powered method.

For this purpose, any one of a commonly known airship, hot-air balloon, and gas balloon filled with helium may be applicable as the flying object 110.

Meanwhile, the flying object 110 is provided with a wind direction sensor 112 capable of measuring the movement direction of the wind and measuring wind speed when necessary on one side thereof, preferably the front side thereof.

Although the measured value of the wind direction sensor 112 is not shown, the measured value is transmitted to a control tower (not shown) on the ground that controls the atmosphere purification apparatus 100 using a flying object, and allows adjustment to be performed to easily search for a contaminated area in the atmosphere and easily move to the location based on the direction and wind speed of the wind.

Furthermore, the flying object 110 is further provided, on one side thereof, with an advertisement unit 111 configured to display an advertising phrase.

In this case, the advertisement unit 111 may display an advertising phrase using an electronic display panel, or may display a desired advertising phrase through printing.

Meanwhile, the flying object 110 is preferably configured to be provided with an internal rechargeable battery or an external solar panel and thus to use its own power source.

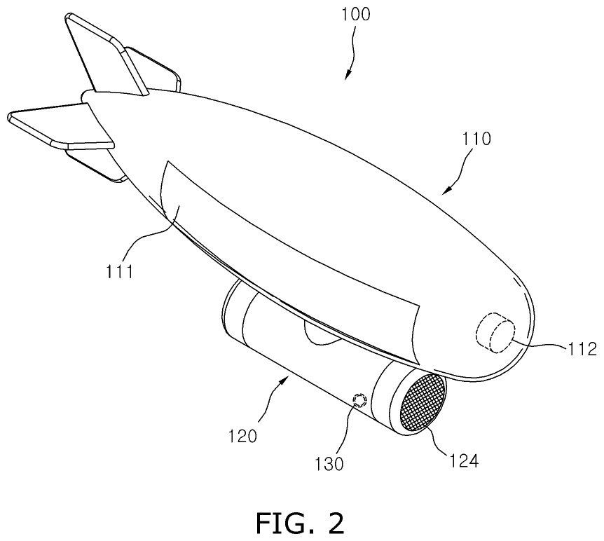

Next, referring again to FIGS. 1 and 2, the air purification unit 120 applied to the atmosphere purification apparatus 100 using a flying object according to the present invention includes a filter 123 in order to remove contaminants D in the contaminated air introduced thereinto.

In this case, the filter 123 may be provided in the form of a single module or a plurality of modules. It is obvious that various filters, such as a HEPA filter and a membrane filter, may be applied depending on the types and characteristics of contaminants in the atmosphere.

More specifically, the air purification unit 120 is provided below the flying object 110. It has a case 121 provided with mesh nets 124 on the front and rear sides thereof in order to facilitate the inflow and discharge of air and to prevent foreign substances in the atmosphere from entering the inside thereof.

Preferably, the case 121 has a tubular shape having a length.

Furthermore, the air purification unit 120 is configured such that the filter 123 is provided inside the case 121 and fans 122 configured to guide external air toward the filter 123 or provide propulsion force to move the flying object 110 are disposed in front of and behind the filter 123.

The case 121 has a structure that can be selectively opened and closed and thus facilitates the replacement and maintenance of the filter 123.

More specifically, in the state in which the flying object 110 is stopped, the above-described fans 122 guide external contaminated air to the inside by adjusting rotating direction and speed so that the contaminated air can be purified. When the flying object 110 searches for and moves to a contaminated region in the atmosphere, the above-described fans 122 provide propulsion force to move the flying object 110 by adjusting rotating direction and speed.

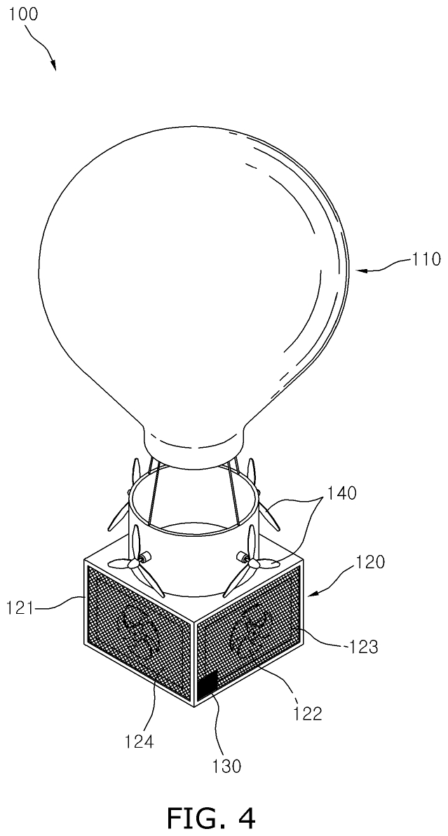

Meanwhile, although not shown in FIGS. 1 to 3, fan propellers (140 in FIG. 4) configured obtaining propulsion force may be configured to be separately included on one side of the flying object 110 or air purification unit 120 in order to obtain a higher propulsion force as needed.

The fans 122 and the fan propellers 140 described above may use their own power source using the internal rechargeable battery or external solar panel of the flying object 110, or may receive and use power through a cable connected from the ground, as in an example that will be described below.

Furthermore, a contamination level sensor 130 capable of measuring a contamination level in the atmosphere is further provided on one side of the flying object 110 or air purification unit 120.

The contamination level sensor 130 measures a contamination level in the atmosphere according to the altitude at which the flying object 110 moves or according to space, and sends a measured value to a control tower (not shown) on the ground. According to a measured value, the flying object 110 is allowed to move to a region having a severe contamination level through adjustment, and a plurality of atmosphere purification apparatuses 100 using a flying object, other than a single purification apparatus 100 using a flying object, is transferred to purify a contaminated region.

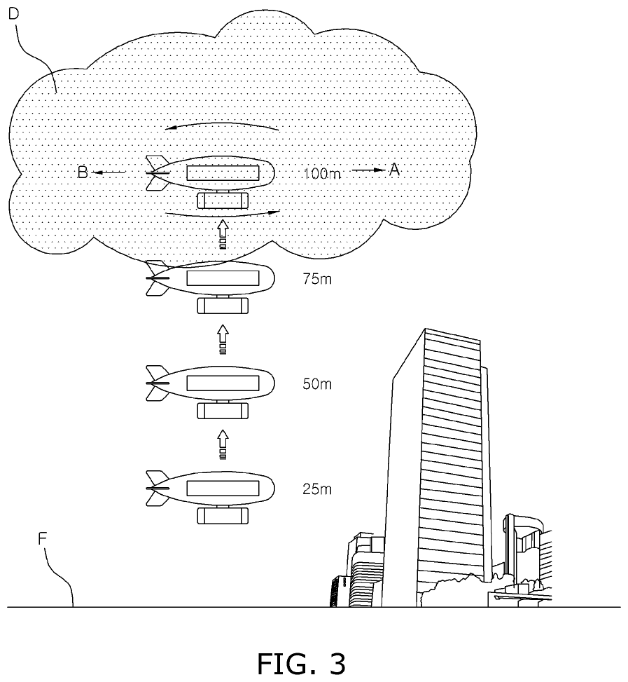

Referring to FIG. 3, the atmosphere purification apparatus 100 using a flying object according to the present invention, which is configured as described above, moves to a region having a severe contamination level according to measured values of the contamination level sensor 130 and the wind direction sensor 112 as the flying object 110 moves while increasing the altitude from the ground F.

Then, when the atmosphere purification apparatus 100 using a flying object reaches the contaminated region, it repeats the process of purifying a contaminated material D in the contaminated space through the air purification unit 120 while repeatedly circling between regions A and B.

Meanwhile, although the flying object 110 is shown in the form of an airship in FIGS. 1 to 3, it can be seen from FIGS. 4 to 6 that the flying object 110 may be applied in the form of a balloon.

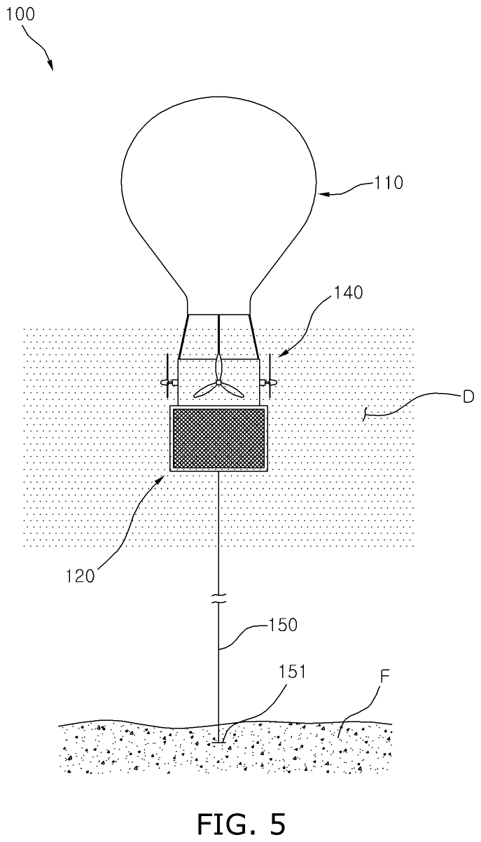

Furthermore, referring again to FIG. 5, the atmosphere purification apparatus 1 using a flying object according to the present invention is configured to include a support cable 150 in order to prevent the atmosphere purification apparatus 1 from leaving an atmosphere purification point due to movement attributable to convection, as needed.

The support cable 150 is configured such that one end thereof is connected to one side of the flying object 110 or air purification unit 120 and maintains a fastened state and the other end thereof is maintained in a state of being fastened at a set point in the ground F by a fastening member 151.

The support cable 150 also serves as a cable as a power source that supplies power when power is required for the flying object 110 or the air purification unit 120, as needed.

Meanwhile, the above-described flying object 110 or air purification unit 120 is configured to further include the fan propellers 140 on one side thereof in order to move the flying object 110 when a location is changed by convection or when it is necessary to move to a specific point requiring the removal of atmospheric contaminants.

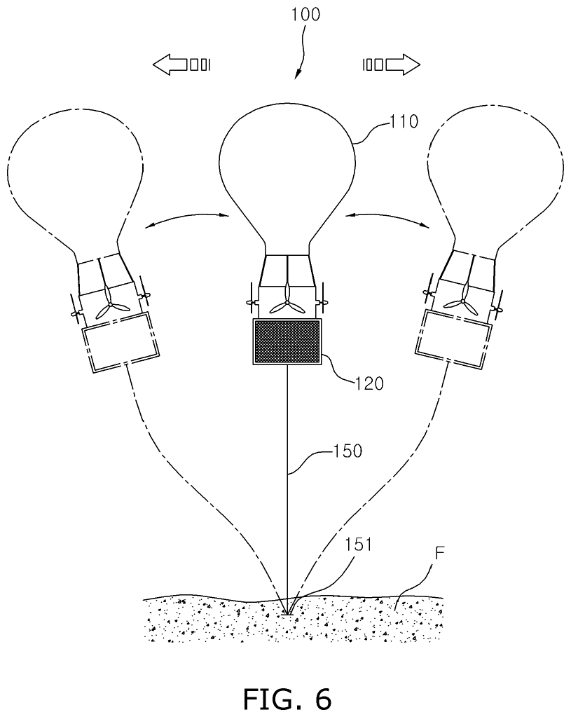

These control propellers 140 may be operated to have propulsion force in the opposite direction to return the flying object 110 to its original position when the flying object 110 is shaken by convection, as shown in FIG. 6, or may maximize the atmosphere purification efficiency of the air purification unit 120 while repeatedly circling across a contaminated region.

In other words, in a contaminated area in the atmosphere, the fan propellers 140 allow the atmosphere purification apparatus 100 to remove contaminants D in the atmosphere while circling across points within a contaminated space under automatic control using a setting control program or control on the ground F.

Preferably, the fan propellers 140 are provided at the locations of the flying object 110 in the east, west, south, and north directions.

As described above, the air purification apparatus 100 using a flying object according to the present invention may remove atmospheric contaminants in a wider range by using the flying object 110 that can stay or circle within a predetermined region in the atmosphere while adjusting the altitude.

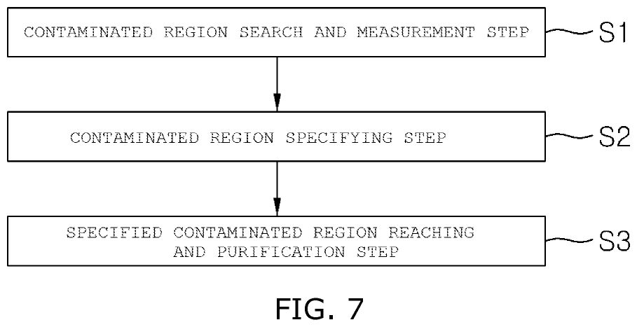

Meanwhile, an embodiment of an atmosphere purification and treatment method using the air purification apparatus 100 using a flying object according to the present invention will be described below with reference to FIG. 7.

The present invention moves the air purification unit 120 into a contaminated region in the atmosphere by using the flying object 110, and allows the air purification unit 120 to purify contaminated air within the contaminated region.

In order to remove contaminants scattered in the atmosphere in a specific contaminated area as described above, the atmosphere purification and treatment method according to the present invention includes a contaminated area search and measurement step S1, a contaminated area specifying step S2, and a specified contaminated region reaching and purification step S3.

First, the contaminated region search and measurement step S1 is the step of determining a location and altitude having a high contamination level in the atmosphere before actual atmosphere purification and treatment using the atmosphere purification apparatus 100.

For this purpose, the contaminated region search and measurement step S1 is configured to include the process of primarily moving the atmosphere purification apparatus 100 using a flying object, equipped with the contamination level sensor, the process of measuring a contamination level for each location and altitude, and the process of transmitting measured contamination levels and locations to a control tower on the ground.

In this case, preferably, a device that is easy to operate and has a small size, such as a balloon, is used as the flying object applied to the atmosphere purification apparatus 100.

As described above, before the actual atmosphere purification and treatment of a contaminated region is carried out, the contaminated region that is the target of the primary movement is searched for and specified. The reason for this is to identify the contaminated region in advance, thereby reducing work time attributable to an unnecessary search process and increasing purification efficiency.

Thereafter, there is performed the contaminated region specifying step S2 of specifying the location and altitude of the contaminated region based on the measured contamination levels.

The contaminated region specifying step S2 is performed in the control tower (not shown) on the ground that has received the measured values and the measurement locations.

Furthermore, when the location and the altitude to be purified are specified due to a high contamination level, the specified contaminated region reaching and purification step S3 follows.

The specified contaminated region reaching and purification step S3 includes the process of secondarily moving the atmosphere purification apparatus 100 using a flying object, equipped with the contamination level sensor and the air purification unit 120, to the specified contaminated region, and the process of performing atmosphere purification and treatment using the air purification unit.

Preferably, an airship that is easy to move and has a large capacity is used as the flying object 110 of the atmosphere purification apparatus 100 that actually performs atmosphere purification and treatment

Furthermore, a plurality of atmosphere purification apparatuses 100 is moved according to the size of the contaminated region.

In this case, the airship is equipped with a GPS and automatically moves to the specified contaminated region according to a set value.

According to the above-described atmosphere purification and treatment method, atmosphere contamination removal efficiency is improved by removing the pollutants scattered in the atmosphere using the atmosphere purification apparatus while staying within a certain region or circulating by adjusting the altitude using the flying object.

The present invention described above is not limited to the above-described embodiments and the accompanying drawings because various substitutions, modifications and alterations may be made without departing from the technical spirit of the present invention by those having ordinary skill in the art to which the present invention pertains.

1. An atmosphere purification apparatus using a flying object, the atmosphere purification apparatus comprising:
a flying object (110) filled with a gas having a lower specific gravity than that of air therein; and
an air purification unit (120) provided on one side of the flying object (110), and configured to remove contaminants introduced thereinto;
wherein the atmosphere purification apparatus guides contaminants in an atmosphere within a region having a height from a ground (F) into the air purification unit (120) and removes the contaminants.

2. The atmosphere purification apparatus of claim 1, wherein the flying object (110) is any one of an airship, a hot-air balloon, and a gas balloon.

3. The atmosphere purification apparatus of claim 1, wherein the flying object (110) is configured to further include an advertisement unit (111) configured to display an advertising phrase on one side thereof, and a wind direction sensor (112) configured to measure a direction of a wind.

4. The atmosphere purification apparatus of claim 1, wherein the air purification unit (120):
is provided below the flying object (110); and
is configured to include a case (121) provided with mesh nets (124) on front and rear sides thereof, a filter (123) provided inside the case (121), and fans (122) disposed in front of and behind the filter (123) and configured to guide external air toward the filter (123) or provide propulsion force to move the flying object (110).

5. The atmosphere purification apparatus of claim 1, further comprising a support cable (150) configured such that one end thereof is connected and fastened to one side of the flying object (110) or air purification unit (120) and a remaining end thereof is installed and fastened at a set point in the ground (F) by a fastening member (151).

6. The atmosphere purification apparatus of claim 1, wherein the flying object (110) or air purification unit (120) is configured to further include fan propellers (140) configured to obtain propulsion force on one side thereof.

7. The atmosphere purification apparatus of claim 1, wherein the flying object (110) or air purification unit (120) is configured to further include, on one side thereof, a contamination level sensor (130) configured to measure a contamination level including fine dust at a located point

8. The atmosphere purification apparatus of claim 1, wherein the flying object (110) includes its own power source using an internal rechargeable battery or an external solar panel.

9. An atmosphere purification and treatment method using the atmosphere purification apparatus using a flying object according to claim 1 in order to remove contaminants scattered in an atmosphere within a specific contaminated region, the atmosphere purification and treatment method comprising:
a contaminated region search and measurement step (S1) including a process of primarily moving the atmosphere purification apparatus using a flying object, equipped with a contamination level sensor, a process of measuring a contamination level for each location and altitude, and a process of transmitting measured contamination levels and locations to a control tower on a ground;
a contaminated region specifying step (S2) of specifying a location and altitude of a contaminated region based on the measured contamination levels; and
a specified contaminated region reaching and purification step (S3) including a process of secondarily moving the atmosphere purification apparatus using a flying object, equipped with the contamination level sensor and an air purification unit (120), to the specified contaminated region, and a process of performing atmosphere purification and treatment using the air purification unit.

10. An atmosphere purification and treatment method using the atmosphere purification apparatus using a flying object according to claim 2 in order to remove contaminants scattered in an atmosphere within a specific contaminated region, the atmosphere purification and treatment method comprising:
a contaminated region search and measurement step (S1) including a process of primarily moving the atmosphere purification apparatus using a flying object, equipped with a contamination level sensor, a process of measuring a contamination level for each location and altitude, and a process of transmitting measured contamination levels and locations to a control tower on a ground;
a contaminated region specifying step (S2) of specifying a location and altitude of a contaminated region based on the measured contamination levels; and
a specified contaminated region reaching and purification step (S3) including a process of secondarily moving the atmosphere purification apparatus using a flying object, equipped with the contamination level sensor and an air purification unit (120), to the specified contaminated region, and a process of performing atmosphere purification and treatment using the air purification unit.

11. An atmosphere purification and treatment method using the atmosphere purification apparatus using a flying object according to claim 3 in order to remove contaminants scattered in an atmosphere within a specific contaminated region, the atmosphere purification and treatment method comprising:
a contaminated region search and measurement step (S1) including a process of primarily moving the atmosphere purification apparatus using a flying object, equipped with a contamination level sensor, a process of measuring a contamination level for each location and altitude, and a process of transmitting measured contamination levels and locations to a control tower on a ground;
a contaminated region specifying step (S2) of specifying a location and altitude of a contaminated region based on the measured contamination levels; and
a specified contaminated region reaching and purification step (S3) including a process of secondarily moving the atmosphere purification apparatus using a flying object, equipped with the contamination level sensor and an air purification unit (120), to the specified contaminated region, and a process of performing atmosphere purification and treatment using the air purification unit.

12. An atmosphere purification and treatment method using the atmosphere purification apparatus using a flying object according to claim 4 in order to remove contaminants scattered in an atmosphere within a specific contaminated region, the atmosphere purification and treatment method comprising:
a contaminated region search and measurement step (S1) including a process of primarily moving the atmosphere purification apparatus using a flying object, equipped with a contamination level sensor, a process of measuring a contamination level for each location and altitude, and a process of transmitting measured contamination levels and locations to a control tower on a ground;
a contaminated region specifying step (S2) of specifying a location and altitude of a contaminated region based on the measured contamination levels; and
a specified contaminated region reaching and purification step (S3) including a process of secondarily moving the atmosphere purification apparatus using a flying object, equipped with the contamination level sensor and an air purification unit (120), to the specified contaminated region, and a process of performing atmosphere purification and treatment using the air purification unit.

13. An atmosphere purification and treatment method using the atmosphere purification apparatus using a flying object according to claim 5 in order to remove contaminants scattered in an atmosphere within a specific contaminated region, the atmosphere purification and treatment method comprising:
a contaminated region search and measurement step (S1) including a process of primarily moving the atmosphere purification apparatus using a flying object, equipped with a contamination level sensor, a process of measuring a contamination level for each location and altitude, and a process of transmitting measured contamination levels and locations to a control tower on a ground;
a contaminated region specifying step (S2) of specifying a location and altitude of a contaminated region based on the measured contamination levels; and
a specified contaminated region reaching and purification step (S3) including a process of secondarily moving the atmosphere purification apparatus using a flying object, equipped with the contamination level sensor and an air purification unit (120), to the specified contaminated region, and a process of performing atmosphere purification and treatment using the air purification unit.

14. An atmosphere purification and treatment method using the atmosphere purification apparatus using a flying object according to claim 6 in order to remove contaminants scattered in an atmosphere within a specific contaminated region, the atmosphere purification and treatment method comprising:
a contaminated region search and measurement step (S1) including a process of primarily moving the atmosphere purification apparatus using a flying object, equipped with a contamination level sensor, a process of measuring a contamination level for each location and altitude, and a process of transmitting measured contamination levels and locations to a control tower on a ground;
a contaminated region specifying step (S2) of specifying a location and altitude of a contaminated region based on the measured contamination levels; and
a specified contaminated region reaching and purification step (S3) including a process of secondarily moving the atmosphere purification apparatus using a flying object, equipped with the contamination level sensor and an air purification unit (120), to the specified contaminated region, and a process of performing atmosphere purification and treatment using the air purification unit.

15. An atmosphere purification and treatment method using the atmosphere purification apparatus using a flying object according to claim 7 in order to remove contaminants scattered in an atmosphere within a specific contaminated region, the atmosphere purification and treatment method comprising:
a contaminated region search and measurement step (S1) including a process of primarily moving the atmosphere purification apparatus using a flying object, equipped with a contamination level sensor, a process of measuring a contamination level for each location and altitude, and a process of transmitting measured contamination levels and locations to a control tower on a ground;
a contaminated region specifying step (S2) of specifying a location and altitude of a contaminated region based on the measured contamination levels; and
a specified contaminated region reaching and purification step (S3) including a process of secondarily moving the atmosphere purification apparatus using a flying object, equipped with the contamination level sensor and an air purification unit (120), to the specified contaminated region, and a process of performing atmosphere purification and treatment using the air purification unit.

16. An atmosphere purification and treatment method using the atmosphere purification apparatus using a flying object according to claim 8 in order to remove contaminants scattered in an atmosphere within a specific contaminated region, the atmosphere purification and treatment method comprising:
a contaminated region search and measurement step (S1) including a process of primarily moving the atmosphere purification apparatus using a flying object, equipped with a contamination level sensor, a process of measuring a contamination level for each location and altitude, and a process of transmitting measured contamination levels and locations to a control tower on a ground;
a contaminated region specifying step (S2) of specifying a location and altitude of a contaminated region based on the measured contamination levels; and
a specified contaminated region reaching and purification step (S3) including a process of secondarily moving the atmosphere purification apparatus using a flying object, equipped with the contamination level sensor and an air purification unit (120), to the specified contaminated region, and a process of performing atmosphere purification and treatment using the air purification unit.
